(19) United States
(12) Patent Application Publication
(10) Pub. No.: US 2008/0027836 A1
(43) Pub. Date: Jan. 31, 2008

(54) Inventory Equalization System

(76) Inventor: Christopher Chapin, San Diego, CA (US)

Correspondence Address: CATALYST LAW GROUP, APC, 9710 SCRANTON ROAD, SUITE S-170, SAN DIEGO, CA, 92121, US

(21) Appl. No.: 11/837,381

(22) Filed: Aug. 10, 2007

Related U.S. Application Data
(63) Continuation of application No. PCT/US06/03166, filed on Jan. 27, 2006.

(51) Int. Cl. G06Q 10/00

(52) U.S. Cl. 705/28

(57) ABSTRACT

A Business Method by which otherwise independent nodes of a distribution system can interact via an internet website or other means to equalize inventory to their mutual benefit and profit, with the Business Method Practitioner operating the mechanism and retaining a percentage of each transaction as a fee for the service provided. In the retail world for which the Business Method is primarily intended, this has the collateral benefits of reducing the percentage of overstock goods sold at a discount and understock goods purchased at a premium, raising the overall profitability of the industry served, protecting branding, and improving performance of individual nodes of the market and of the overall market.

### RELATED APPLICATION

This application is a continuation of International Application No. PCT PCT/US06/03166, filed Jan. 27, 2006, which claims priority to U.S. Provisional Application No. 60/648,906, filed Feb. 1, 2005, both of which are incorporated herein by reference in their entirety.

### FIELD OF THE INVENTION

The present invention relates generally to the field of product inventory control, where imperfect stocking or manufacturing decisions can result in accumulations of excess inventory at some points and deficiencies of inventory at other points. The present invention provides systems and methods by which users can cost-effectively and profitably equalize inventory, facilitating the movement of items from geographic markets and participating nodes in which they are slow-moving to geographic markets and participating nodes in which they are faster moving.

### BACKGROUND OF THE INVENTION

There exists a spectrum of methodologies by which inventory is managed by retailers with multiple outlets, distributors, wholesalers, and manufacturers with multiple distribution points, all intended to improve profitability of the overall system optimizing the relationship between the cost of maintaining inventory and the revenue generated by that inventory. The systems and methods of the prior art attempt to manage inventory by forecasting and optimizing movement of inventory from manufacturer to consumer. These inventions are directed towards such things as systems and methods for managing the rate of use of inventory by a supplier and calculating therefrom the proper time for ordering more inventory. Also, systems and methods for managing variable priced inventory, e.g., travel services, using a multi-layered SKU system. And, systems and methods for moving inventory from storage to the sales floor before the storage cost per item causes the retailer's profit to significantly diminish. U.S. Pat. No. 6,643,626, issued to Perri de Resende and titled Sales Point Business Method and Apparatus, generally describes remotely monitoring a display case having merchandise. The described purpose for remotely monitoring the display case is to assure that authorized users are accessing the merchandise, to monitor transactions involving the merchandise, and/or to provide security against theft, fire and other hazards. This invention allows for the remote monitoring of merchandise to detect the depletion of the merchandise, whether by desired or undesired means. The invention does not provide a means for managing the merchandise inventory amounts.

U.S. Pat. No. 6,405,177, issued to DiMattina and titled System for Securing Commercial Transactions Conducted On-Line, generally describes a system and method allowing on-line retailers to offer guaranteed financial services in addition to their goods. The financial services are such things as secure credit card transactions, price guarantees, guaranteed delivery and return policies and implied warrantee guarantees. The system for accomplishing this method comprises a purchaser-retailer transaction means, a single action (“one click”) component and a means for sending the financial services certificate to the purchaser. While this patent is related to selling a retailer's inventory, it in no way is capable of managing inventory.

United States Patent Application No. 2005/0075945, by Matsumoto et al and titled Inventory Management and Ordering System, and Ordering Management System Using the Previous System, describes a system for managing a businesses inventory. The system monitors the quantity of an item inventory and the rate of use is determined so that future order dates can be predicted. Orders are placed based on the forecast, thereby keeping an adequate supply of an item. While this invention recognizes the need for inventory management, it focuses only on timely ordering of supplies to maintain an item on hand. The dynamics of inventory management being much more complex than striking a balance between use of goods and ordering of goods, this invention is limited to only a small sub-set of inventory management.

United States Patent Application No. 2003/0036981, by Vaughn et al. and titled System and Method for Managing Inventory, describes a method and system wherein a retailer provides available inventory to a server and a potential consumer can shop the inventory from the server. The invention is that the inventory, which is related to travel, is defined in the travel server by SKU group, record and unit. These different levels of SKU are necessary with travel-based inventory, which is unique inventory. For example, the price of a single travel-based good can vary based on how far in advance the good is purchased. This invention provides a means for accounting for such variance in goods price. The retailer provides information for the SKU levels on available inventory, and the potential consumer searches for specific products based on a query that is addressed and processed at the SKU levels. The server matches the two. This invention manages inventory by providing a specific means to shop for travel based goods.

United States Patent Application No. 2005/0033666, by Kurashige and titled Inventory Management Method and Program Product, generally describes a management server having an inventory database, a purchase database and a sales database. The server is designed to track certain inventory indicators and uses these indicators to move goods from inventory to sales. By tracking these indicators, inventory that is kept in storage can be moved to sales before the cost of the storage factored into each good diminishes the profits. It is desirable to keep products flowing from storage to the sales floor and in turn out the door. But this patent does not address the problem of inventory that does not sell or inadequate inventory to meet demand.

United States Patent Application No. 2005/0004831, by Najmi et aL and titled System Providing for Inventory Optimization in Association with a Centrally Managed Master Repository for Core Reference Data Associated with an Enterprise, describes a system and method for developing an inventory plan for a supply chain. The supply chain is defined as the chain of participants beginning with suppliers including the manufacturers and vendors and ending with the consumer. The inventory plan is an optimized plan that assures that the members of the supply chain are able to predict proper inventory amounts based on a variety of defined metrics. If metrics reach a critical/problematic point, the plan is adjusted to account therefore. New metrics can be added. This invention recognizes and addresses the problems with overstock and understock in a supply chain and attempts to develop a dynamic inventory plan that will prevent the occurrence of these problems. However, given the unpredictable nature of the consumer, this invention cannot address inventory problems that arise from an unexpected change in consumer demand.

Inventory excess: At any level (manufacturer, distributor, wholesaler, or retailer), inventory excess is expensive, and there have evolved many business methods for dealing with the problem. The most visible and obvious is to discount the price from the planned one, motivating buyers in the chain to move the merchandise. This has the effect of reducing margins and therefore profits, but is a better business method solution than doing nothing, which results in languishing and obsolescing inventory.

Another method for dealing with the problem is to package such obsolescing product, discount it, and ship it to off-price distributors and retailers, which has the same net effect of reducing margins and profits. Both of these steps have another effect that is highly negative and not as visible; branded merchandise appears for sale at a discount, which owners of such brands work hard to prevent. Many brands are protected aggressively. There are often agreements between the distribution system and the manufacturer or importer intended to prevent such discounted sales, or transfers to distribution that is not pre-authorized by the manufacturer or importer.

In such cases, branded merchandise manufacturers often establish a buy-back program to help prevent discounting, by authorized outlets, and to help prevent their merchandise from reaching discount outlets. Such returns come at a high price, however.

First, they result in a credit against future orders, which does not help a cash-needy situation.

Second, they are credited at a high discount compared to the original shipping invoice (15% or more). Third, retaining the right to sell a particular brand often requires maintenance of a certain volume of sales, and returns negatively impact that volume and can jeopardize retention of that sales right.

Another business method that has emerged to deal with the problem is clandestine shipment by an authorized dealer in branded merchandise to an unauthorized dealer. This is usually a violation of the contract between the authorized dealer and the distributor or manufacturer, and sometimes occurs via nighttime transfers to trucks in alleys, but has the effect of converting excess inventory into ready cash. The risk is to the “franchise” held by the authorized dealer, but in the absence of trackable serial numbers that risk is small, and the result is a loss of brand protection.

Excess inventory is expensive, and its value decreases steadily. That decrease is often more rapid than the rate of sale of the stock, and waning sales often will not even replace the cost of money spent to buy the inventory in the first place. Tax authorities recognize the situation and permit deductions for obsolescing inventory, acknowledging that costly aspect of doing business in a supply-demand system where prediction is imperfect. A cost-effective business method that satisfies the problem would increase profit for every link in the system.

For all these reasons and more, all components of the system including manufacturers, wholesalers/distributors, and retailers seek ways and means to relieve the excess inventory problem.

Inventory deficiencies: The obvious solution to a deficiency in inventory is to place an order for more. At the retail level, and sometimes at the wholesale/distribution level, that obvious solution is impractical. When the original imperfection in judgment resulted in one or two items selling out earlier than expected, or the unplanned success of a particular style or color of an item, it may not be cost-effective to place a re-order if there are often minimum order quantities, or penalties when orders are below some threshold. Some items, in fact, may be orderable only in arrays that consist (as an example) of one gross of each color. When an item sells out in the two colors of a local university, for example, it may not be cost effective to order twelve gross, ten gross of which will languish along with the original shipment.

In many such cases, the deficiency remains unsatisfied because there is no method by which the order can be filled cost-effectively.

Further, re-order items may not be available at the factory or distributor level because they are back-ordered, closed out, or discontinued, resulting in lower profitability for the retailer whose inventory is comprised of partial size runs or limited color options, etc., making the product difficult to sell.

When all components of a distribution network are members of the same system, and all are interconnected by inventory management software, communications, and logistics mechanisms (shipping), software can be devised to (1) recognize inequities, (2) react to trigger points, (3) make recommendations to management, (4) monitor the logistical implementation of solutions, and (5) create data structures that suggest improvements to ordering protocols that lessen the likelihood of repetitive problems. This is a method by which organized distribution systems can be optimized to reduce obsolescence, minimize investment in inventory, improve overall profitability, protect branding, and maintain brand franchises.

At the other extreme, a retailer with a franchise to sell protected branded merchandise will load excess merchandise onto a truck at night and ship it to another outlet, unauthorized by the brand manager, and despite any obligation to not do such.

Between these two points exist many different potential solutions, of which none works well enough to satisfy the preponderance of the problems in the real world marketplace.

Problems with existing inventory management systems.

One problem with many existing inventory management systems is that they report to management when a given monitored item reaches a re-order level at a given location or storage point, but do not compare levels of different locations or storage points and report comparative levels.

Another problem with existing inventory management systems that monitor inventory levels at multiple sites is that they are not constructed to consider the value of the equalization of inventory between nodes (locations, or storage points, or distribution points).

Another problem is that many such systems do not provide a mechanism to recognize the cost of an overstock at one point, with aging and obsolescing inventory, with a simultaneous understock at a second point, with loss of sales due to non-availability.

Another problem is that many such systems that do provide a mechanism that recognizes the importance of differential inventory levels, due to geographic preferences or errors made in placing orders, usually stop re-orders of obsolescing inventory and increase orders of understocked inventory, thus correcting the imbalance over time but in the least profitable manner.

Another fundamental problem with all such existing inventory management systems is that they apply exclusively to members of an integrated organization and not to transients or otherwise unaffiliated business units, and therefore the beneficiaries of such systems are only those who are part of that organization. For example, such a system that addresses the national distribution of product X might have the potential to do so for the organization that “owns and operates” the system, but not for the sole-site business that might benefit from its use, even if that sole-site's participation might assist the organization that operates the system by reducing its logistics costs.

While many of the prior art inventory management and equalization solutions may be suitable to one degree or another for the particular limited requirements they address, they are not optimum or generalized solutions for broad and diverse multi-node retail, wholesale, and distributor markets, do not meet the needs of transients passing through the system to satisfy inventory imbalance requirements, and are not sufficiently flexible to be adaptable to the needs of many potential users.

### BRIEF SUMMARY OF THE INVENTION

In view of the foregoing disadvantages inherent in the prior art, the present invention diverges therefrom to provide systems and methods that satisfy the needs of multiple geographic nodes at the retail, wholesale, distribution, and even manufacturing levels, thereby improving cost-effectiveness and therefore the profitability of the business segments that adopt it.

The main objective of the present invention is to provide a cost-effective brokering mechanism by which multiple nodes, geographically diverse and each managing its own inventory can efficiently interchange items that have accumulated at one point and become deficient at another.

Another objective is to provide a channel of efficient communication by which at least two geographically diverse nodes of a distribution system, each managing its own inventory and with one suffering an understock of a given item while the other has an overstock condition of the same item, can negotiate the transfer of merchandise in one direction and funds or credits in the other.

Another objective is to provide a brokerage or equity/credit management system by which participating nodes can make deposits by shipping items to other participants, and from which they can make withdrawals by ordering items from other participants, with the system holding the credits in the interim.

Another objective is to provide an accounting system that collects, correlates, checks, and reports on all activities, facilitating record-keeping by participants.

Another objective is to provide filtering to ensure that branded items, the distribution of which is controlled by the manufacturer or distributor, are not passed from an authorized node to a non-authorized node of the system.

Another objective is to provide an internet website on which nodes, typically retail or wholesale businesses, can log in and define their needs, whether to divest or acquire uniquely identified merchandise, thus seeking counterparts with the complementary needs with whom transactions can be negotiated.

Another objective is to provide non-website means by which internet communication (e.g., email or ftp) can be used to list surpluses and requirements which will then be manipulated and managed by manual means within the staff of the practitioner of the Business Method, thus stimulating transactions.

Another objective is to provide non-internet means by which communication (e.g., fax, telephone, postal service, or direct personal contact) can be used to list surpluses and requirements which will then be manipulated and managed by manual means within the staff of the practitioner of the Business Method, thus stimulating transactions.

Another objective is to provide control mechanisms within the system to ensure that brokerage services, banking, payments, credits, brand protection, representations, warrantees are as described by participants, by various means including a peer-rating system plus an oversight review and point-awarding system.

Another objective is to provide a mechanism and system by which participating nodes can relieve inventory overstock issues without the penalty of paying overstock charges to distributors or manufacturers.

Another objective is to provide an overall Business Method for the equalization of inventory that generates support and endorsement by business entities seeking to protect brand integrity, by reducing the likelihood of clandestine shipment of branded merchandise to off-price outlets, discounting, and other ex-franchise activities.

Another objective is to provide a mechanism and system to accumulate detailed product data, plus node, date, volume, and all other useful data, making such information available to all tiers of the system and to distributors, manufacturers, etc. Since such information is of commercial value it is expected to evolve into a revenue source for the implementer of the system.

Another objective is to provide a mechanism and system that can be readily applied to other problems of supply and demand, such as in manufacturing where one manufacturer has an abundance of a little-used raw material and another has a deficiency thereof and both benefit from equalization of their inventory via a cost-effective means for achieving a transaction.

It is the intention of the inventor that these objects apply equally to all business methods involving an inventory equalization system applicable to any defined product category, characterized by (1) remote access by any business entity with an inventory surplus, (2) remote entry of excess inventory and its characteristics, (3) remote access by any business entity with an inventory deficiency, (4) automated or manual matching of surplus to deficiency and of one party to the other, (5) a transaction resulting in equalization of the inventories of the participating parties, and (6) fees paid to the practitioner of the Business Method facilitating the process.

The present invention is most efficient using internet communication (website or email), but the Business Method can be executed by other means, including direct telephone, fax, or even postal communication resulting in information manipulation by manual (i.e. 5″×7: cards) or computer means. The aspect of the invention that is most critical in defining its unique attributes, and that best differentiates it from other operating methods for managing inventory differentials, is the result enjoyed by the business entities that use it.

Other objects and advantages of the present invention will become obvious to the reader and it is intended that these objects and advantages be within the scope of the present invention.

To the accomplishment of the above and related objects, this invention may be embodied in the forms illustrated in the accompanying specification and drawings. However, the specification and drawings are illustrative of selected preferred embodiments, and the invention is not to be limited thereby. There are many possible configurations and derivatives lying within the intended scope of the invention.

### BRIEF DESCRIPTION OF THE FIGURES

FIGS. 1-7 depict preferred embodiments of the current invention showing the flow of information through the present invention, as it might be deployed in support of a random assembly of nodes (herein, retail establishments).

Various other objects, features and attendant advantages of the present invention will become evident to one of ordinary skill in the art given this disclosure. However, these obvious alternatives and derivatives are well within the spirit of the current invention.

FIG. 1 depicts some number (four in the example) of otherwise unaffiliated, unconnected retail stores, each subscribed to the operation of the current invention. Each retail store is referred to herein as a “Node.” In this FIGURE, the nodes are each numbered uniquely 12, 14, 16 and 18, and are collectively referred to as 101. Each node has three overstock items and three understock items, identified by a Stock Keeping Unit (SKU) number of eight digits (in the example shown). All nodes are communicating their status, including both over (available) and under (sought) items to the invention inventory management system via the internet or other communication means. Therefore, the inventory management system has access to all reported over- and under-stocked items of participating nodes and each item is uniquely identified by SKU.

FIG. 2 reflects a computational process within the exchange processing means in the invention, during which all communicated mis-stock information is compared. Complementary matches identified; a “complementary match” being an event in which one node has an under condition and another node an over condition of the same SKU, and the understocked participant having authorization to sell the brand represented by the SKU.

FIG. 3 shows a match report being made to each node of a possible transaction. At this point, the participants are preferably unknown to each other and might be geographically very distant.

FIG. 4 shows payment (by any of many means) by the understocked node to the exchange processing means, which notifies the overstocked node to prepare to ship.

FIG. 5 illustrates disclosure to both participating nodes of the other's identity, address, etc.

FIG. 6 illustrates shipment of merchandise to understocked node, and transfer of flnds/credit to formerly overstocked node via the inventory management system of the current invention.

FIG. 7 illustrates the basic embodiment of the current invention inventory management system

### DETAILED DESCRIPTION OF THE INVENTION

As used herein, the term “mis-stocked” is applied to overstocked inventory and understocked inventory. Also, variations of the word may be used, e.g., “mis-stock” and “mis-stocking”.

As used herein, the term “node” refers to a manufacturer, retailer, distributor, wholesaler or other business entity dealing with inventory and desiring to manage inventory using the current invention. The term “at least two nodes” refers to these same entities when using the invention system wherein there must be at least one overstocked entity and at least one understocked entity.

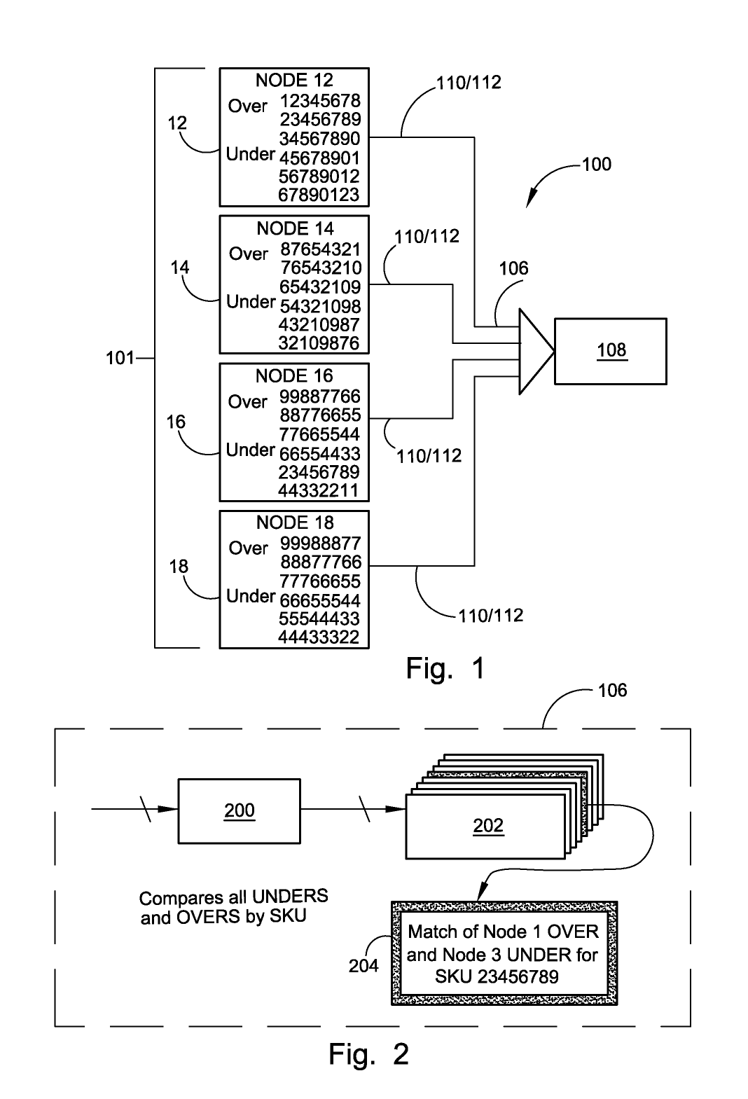

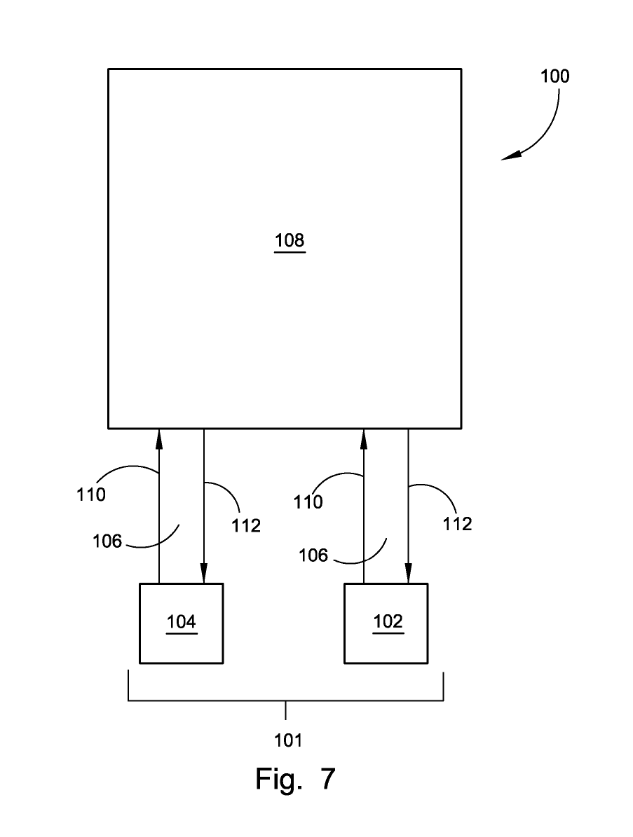

Turning to the FIGURES, one embodiment of the current invention system and method is described. In the preferred embodiment, the inventory management system (IMS) 100 comprises at least two nodes 101, a communication means 106, and a exchange processing means (EPM) 108. FIG. 7. The nodes (e.g., 12, 14, 16 and 18 of FIG. 1 or e.g., 102 and 104 of FIG. 7) comprising the at least two nodes 101 of the invention are preferably retailers engaged in buy/sell of related products. For example, and as used herein, the retailers are shoe retailers. In addition to the retailer not being limited to the shoe business, the invention is also useful management of inventory for the suppliers, manufacturers, distributors and other parties who are involved the supply chain of businesses involved in ultimately getting product to the consumer or an end user.

FIG. 7 communication means 106 comprises a means for transferring inventory information between nodes, 102 and 104, of the at least two nodes 101 and the EPM 108. In the preferred embodiment, the communication means 106 comprises both data input means 110 and data receipt means 112. Furthermore, the communication means 106 can be any of a variety of means, including, but not limited to, computer based communication, telephone based communication, and paper based communication. Still further, communication means 106 can be a computer and monitor linked to the internet. Those of ordinary skill in the art will readily employ these and other communication means with the current invention.

The data input means 110 and the data receipt means 112 will function in a way that suits the communication means 106 employed. For example, if the communication means 106 is a computer, then the data input means 110 is any means of data input that is compatible with a computer, for example, is a keyboard. Similarly, the data receipt means 112 is any means of data input that is compatible with a computer, for example a monitor or a printer.

It is notable that the IMS 100 can be configured to allow each node comprising the at least two nodes 101 of the system to have its own communication means 106. For example, node 104 can have a computer as the communication means 106, while node 102 can have a phone as the communication means 106. In this example, the data that is input via a computer from node 104 can be received via the telephone by node 102. This is a digital to analog (voice) conversion. Other data conversions include, but are not limited to, computer to paper printer one direction, optical character recognition the other direction), and voice to computer (voice recognition software one direction, and voice over/voice readback software the other direction). Conversion of data from one to another communication means 106 is readily accomplished by those of ordinary skill in the art.

Data input to the inventory management system 100 should describe the inventory. This is inventory data and it typically describes a node's inventory and whether that inventory is overstocked or understocked. In its most basic form, the input data can be a description of the inventory drafted similar to an advertisement or a technical specification sheet. A query using terms within the description will produce the description. This means of data input and data retrieval is similar to the technology employed by search engines for finding web pages. Also similar to web pages, this means is inefficient in that a variety of tangentially related inventory descriptions having the query words will be produced and the user will have to manually review these documents for relevance. Similarly, by not using the proper search terms, inventory descriptions can be missed.

In the preferred embodiment, data input to and retrieved from the IMS 100 is described using industry wide acceptable descriptors, and more preferably, this is a stock keeping units (SKU) although any unique identifier could be employed. The SKU standardizes the description of inventory so that the users quickly and efficiently query inventory in the system. SKUs are often times a series of numbers.

The EPM 108 of the IMS 100 is preferably in silico, and is most preferably a computer database. EPM 108 preferably comprises an inventory data storage function, an inventory data comparison function and a comparison communication function for receiving and comparing inventory data. EPM 108 further may comprise a complementary match ranking function for communicating the most relevant complementary match to one node of the at least two nodes. This is useful when there is more than one match of complementary inventory. EPM 108 further may comprise a transaction management function for orchestrating payment and inventory shipping by and between nodes determined to have complementary matching inventory. In this embodiment, EPM 108 holds in memory all of the inventory descriptions. The EPM 108 also receives queries for inventory and then searches the inventory descriptions in memory, comparing the inventory query with the inventory database. Inventory and query matches are called complementary matches and are presented to the nodes 101 so that an inventory transaction can proceed.

In an alternative embodiment, the EPM 108 also guides the transaction following a query match with listed inventory. For example, node 102 inputs to EPM 108 via input means 110 a SKU representing inventory that node 102 has as overstock. Node 104 inputs to EPM 108 via input means 110 a query for inventory using a SKU for inventory that is understocked. EPM 108 receives the query and matches the query with the overstock stored in the database. EPM 108 then communicates the overstock inventory available to node 104 via the data receipt means 106. Node 104 can either accept or reject the presented overstock. Should node 104 accept the presented overstock, the acceptance can be communicated to node 102 in a variety of ways. For example, the overstock inventory that is communicated from the EPM 108 to node 104 via data receipt means 112 may have the contact information for node 102. This being the case, node 104 will contact node 102 and request the overstock inventory.

Preferably, however, the EPM 108 will perform the transaction. In this instance, node 104 communicates to EPM 108 that an overstock inventory is accepted. EPM 108, in turn, communicates this acceptance to node 102.

Others aspects of the transaction, such as payment to node 102 by node 104 for the overstock inventory, shipment notice, and receipt of goods notice, for example, can all be handled by EPM 108.

An additional feature of the described inventory transaction that can be handled by communication means 108 is managing authorized users. As discussed above, many manufacturers, particularly high quality brand name manufacturers, prefer that their merchandise is not sold by certain types of retailers. Typically, such retailers are discount retailers. To prevent such trafficking in goods using the current invention IMS 100, EPM 108 can require that the nodes 101 present authorization before a query into a certain inventory will produce any results. So, in this situation, node 102, having an overstock of an inventory will input the SKU to IMS 100 using communication means 106. Node 104, having an understock of an inventory will query IMS 100 using communication means 106. The inventory in this example is high end inventory and the manufacturer only wants exclusive retailers to sell this inventory. Before the overstock inventory is communicated to node 104, node 104 must qualify as an authorized retailer of this inventory. Identification numbers and passwords are one means for determining authorization, but this is just one example and others are readily apparent to those of ordinary skill in the art.

The invention is further described by these following examples. In the examples, the node is a retailer, though it could be any entity that deals with inventory, from the manufacturer to the distributor. Also, for simplicity, the invention is described using a computer as the communication means and the comparison means is likewise in silico. Variations to these examples are well within the skills of those ordinarily skilled in the art. These variations are well within the spirit of this current invention.

In FIG. 1, there is shown a series of four nodes, 12, 14, 16 and 18 comprising at least two nodes 101, and an exchange processing means 108. The nodes 101 are in contact with the EPM 108 via communication means 106, which comprises data input means 110 and data retrieval means 112.

In this example, IMS 100 is an internet web site for a particular product line or product category. There are many possible product lines and categories to which the invention properly applies, and each has its own characteristics and jargon that distinguish it from others. To facilitate understanding only, but not to exclude other applications, the invention will be discussed as it applies to the retail shoe business. Thus, the nodes 101 are retailers in the shoe industry.

It is also preferred in this example that all inventories managed by the IMS 100 are uniquely identified as to model number, style number, inventory number, color, manufacturer number, etc. using a SKU. As discussed above, the SKU allows the nodes 101 to readily conduct transactions in accordance with industry-wide unified market jargon, descriptive terms, and specific product identifiers.

Also in this example, the invention will be discussed as it applies to individual retail shoe stores or to small groups of retail shoe stores, but not to national chains or retail shoe stores or to national chains of general-merchandise stores that operate integrated shoe departments. The exclusion of those categories from this explanation does not mean the invention is not applicable to their operation. Rather, it is applicable, but explanation is simplified by limiting it to the least complex model and then expanding.

This example comprises a national array of independent, individually-owned retail shoe stores, each selling a mixture of brand-protected and other merchandise.

The example uses the website option, but that does not exclude the potential of using other communication and information management mechanisms.

### EXAMPLE

At least two nodes 101 comprises, in this example, four nodes, 12, 14, 16 and 18. Each of the at least two nodes 101 have overstock and understock. Each of the nodes 101 communicates their overstock and understock to the IMS 100 using a communication means 106, typically a computer connected to the internet and addressed to the IMS 100 website. In this example, IMS 100 is an internet based system, so the communication means 106 is a computer and monitor. Each node 101 identifies its overstock to the EPM 108 via the computer/monitor communication means 106.

Node 12 has a surplus of 24 pair of shoes identified as SKU #23456789 (distribution of which is protected/defended by the manufacturer), which retail at $100 and wholesale at $40. Node 16 has a corresponding deficiency, but neither knows of the other and they are at least 1000 miles apart. Both are aware of the IMS 100 online.

Node 12 enters the IMS 100 website, registers, and goes through a semi-automated qualification process (or was prequalified by previous activity). This optional step is referred to as the authentication process and is useful for managing the nodes when the inventory is designated as that which can only be sold by approved retailers. For example, high quality brand named merchandise is frequently prohibited from being sold in bargain/discount retail establishments. Because it is desirous to prevent the shipment of overstocked inventory of this type to an unauthorized retailer, the current invention is optionally equipped with a function for maintaining transactions only between authorized nodes. Node 12 communicates the overstock and understock of shoes to EPM 108 using the computer and monitor communication means connect to the internet. In this example the overstock and understock are described using a simple SKU number. These SKU numbers are attached to a specification of the shoes, and so, the shoes are presented to the IMS 100 in detail. Node 12 is shown in FIG. 1 listing overstock SKU nos.: 12345678, 23456789, and 34567890, and listing understock SKU nos.: 45678901, 56789012, and 67890123. In addition to the inventory descriptor (SKU), Node 12 enters the over/under quantity for each inventory item listed.

Node 16 also enters the IMS 100 website, qualifies (or was prequalified by previous activity), and lists various overstock and understock SKUs and over/under quantity. In FIG. 1, node 16 is shown listing overstock SKU numbers 99887766, 88776655, and 77665544 and understock SKU numbers 66554433, 23456789, and 44332211. Further, nodes 14 and 18 are shown listing overstock and understock inventory by SKU number. The software behind the IMS 100 website, which comprises EPM 108 compares the entered SKU data and finds the tentative match between node 12's overstock SKU number 23456789 and node 16's understock SKU number 23456789. See FIG. 2. Nodes 12 and 16 are notified of the possible match via communication means 106.

In FIG. 2, the SKU information communicated to EPM 108 is stored in a database and the SKU numbers and any other provided information is compared. In the embodiment wherein a SKU is not used, or where the SKU is limited in the data associated therewith, thus being supplemented, information provided can include, but is not limited to, sizes, colors, quantity over/under, and digital images, or any other relevant detail as determined by the retailer and the inventory product all collectively adding up to a unique identifier for a given product.

FIG. 2 shows that EPM 108 compares all SKU entered and connects complementary overstock SKUs with understock SKUs. This step is labeled comparison step 200. In the current example, node 12 has an overstock of SKU 23456789 and node 14 has a complementary understock of SKU 23456789. This example shows a simple complementary match; however, given the volume of inventory that will be provided by numerous nodes using the invention system, complementary matching can be more extensive and difficult.

For example, supposing that a first node has an overstock of 100 units of inventory and both a second node and a third node have an understock of this same inventory; second node being understocked by 50 units and third node being understocked by 150 units. All three nodes are using the current invention system. It is more efficient for the first node to send the 100 units of overstock inventory to a single location, thereby reducing costs of shipping and preparing for shipping and etc. So, in this scenario, the invention system takes into account that the better complimentary match is the first node with the third node, than the first node with the second node, remainder to the third node. This and other such efficiencies comprise part of the EPM 108 in an alternative embodiment.

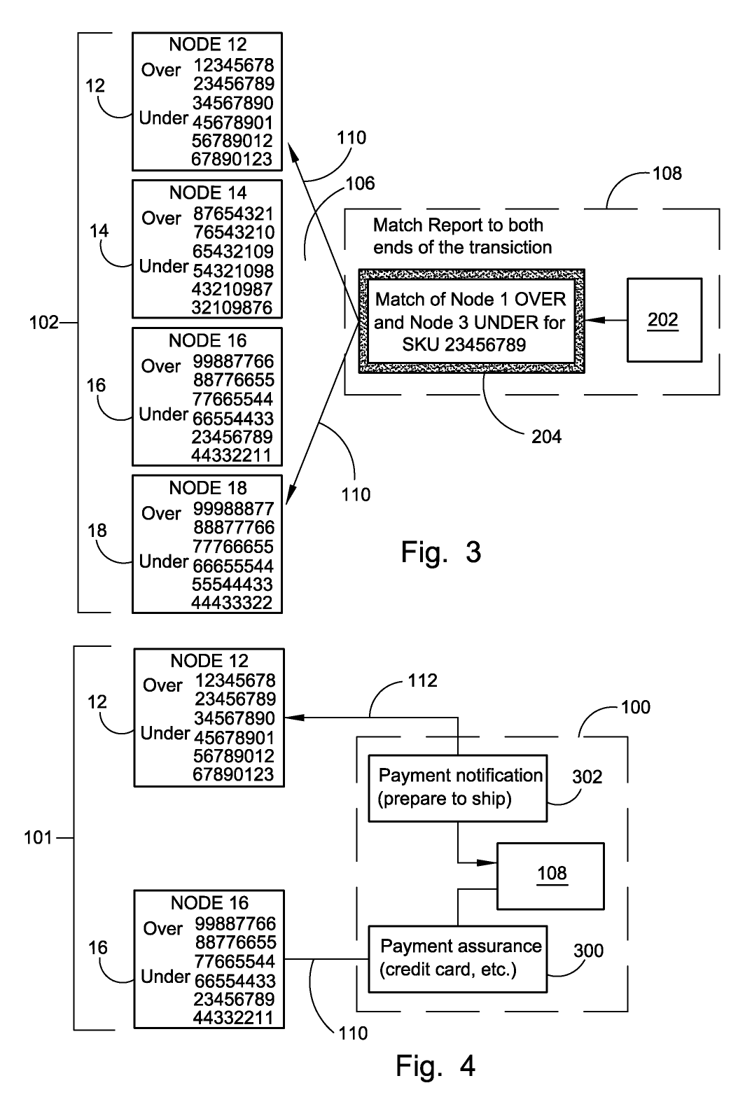

Comparison step 200 generated complementary matches 202, and from there presents match report 204, which is the complementary match that will be communicate back to the nodes 101. FIG. 3 illustrates match report 204 being generated from complementary match 202 and being communicated via communication means 106 to node 12 and node 16.

In FIG. 3, the complementary match 202 generates match report 204. Match report 204 can be selected from the group of complementary matches 202 based on one or more of a variety of factors, including, first to match, best fit, date since SKU upload and others. Those ordinarily skilled in the art will employ these factors for generating match reports 204 that best suit any particular set of nodes, inventory and desired goals using this current invention. Use of these various factors is well within the spirit of the current invention. Match report 204 is communicated to node 12 and node 16 using communication means 106, which in this embodiment is a computer and monitor. Communication can also occur in a variety of ways, for example, node 16 having the understock can be notified first, and if node 16 decides to accept the overstock inventory of node 12, then node 16 can communicate acceptance to the IMS 100 system. The communicated acceptance is in turn communicated to node 12. Should node 16 decide to reject the overstock inventory of node 12, then node 12 is not notified of the solicitation, and IMS 100 will communicate a match report 204 to the next best fitting node as held in complimentary match 202. Node 16 can accept or reject the inventory presented in match report 204, thus completing the inventory management using the IMS 100.

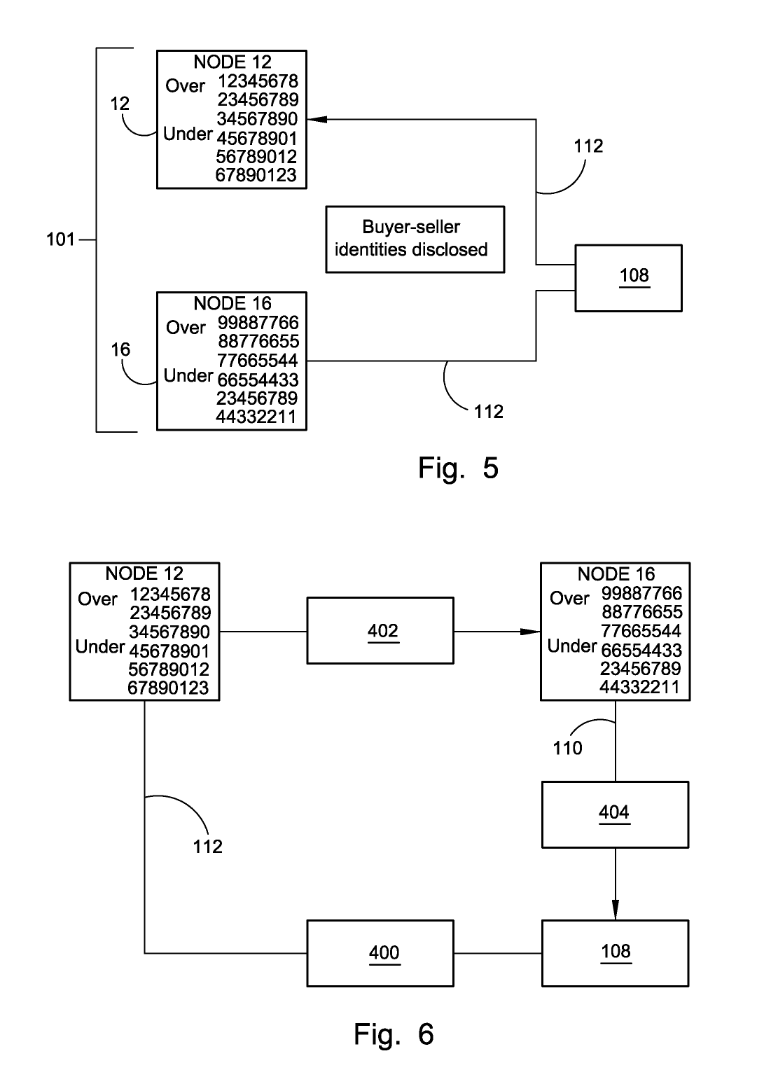

FIG. 4 illustrates an alternative embodiment wherein the IMS 100 also facilitates payment for and shipment of the inventory between two nodes. Again, node 12 has an overstock and node 16 has an understock, and node 16 has accepted the overstock inventory from node 12. In this alternative embodiment, node 16 can accept the node 12 overstock by submitting payment 300. Payment submission 300 is preferably by credit card, but can be any payment method, including, but not limited to wire transfer, check, credit card, charge against PayPal or similar, charge against BMP account, etc. The payment submission 300 is transmitted to the EPM 108 of IMS 100 using communication means 106, which is preferably a computer and monitor with access to the internet. EPM 108 then communicates payment notification 302 to node 12, thereby instructing node 12 to ship the inventory. As shown in FIG. 5, identities of nodes 12 and 16 are revealed to each other during the payment/shipment process.

In an alternative embodiment of the payment transaction the IMS 100 does not facilitate the entire payment from node 16 to node 12 for the inventory exchange, but rather only directly accepts a commission payment. Payment for the inventory, in this case, is made directly from node 16 to node 12. The only role of the IMS 100 for the inventory payment transaction is to provide payment information between the nodes, but not actually receive the payment itself. This arrangement removes the IMS 100 from the payment transaction. IMS 100, therefore, is only directly receiving the commission payment and is only liable for credit card fees on that commission payment, rather than the credit card fees on the commission payment and inventory purchase price.

It is preferred, but not necessary, that the identities of the nodes 101 using IMS 100 are kept private by IMS 101 until after the transaction is secured. Privacy achieves a lot of objectives, including preventing nodes from using the system to scan for inventory and then arranging transactions directly. Such direct transactions results in loss of profit for the manager of the IMS 100 system. This is because the manager of the IMS 100 system will likely receive a payment for administering the transaction. So, in this case, the identities of nodes 101 are kept private so that the IMS 100 manager can realize a business objective. Still, this is only a preferred embodiment, and embodiments where the nodes' identities are public is also possible. In this type of a situation, for example, the nodes 101 may pay a membership fee to browse, and list inventory on IMS 100. Further still, this public identity situation may apply when the manager of the IMS 100 is part of a single business entity managing inventory within satellite business units, which comprise the nodes 101. Varieties of other possibilities exist and are obvious to the ordinary practitioner in the art.

In a preferred embodiment of the current invention, FIG. 6, there is also provided the additional feature wherein IMS 100 holds the payment received from node 16 for the overstock inventory of node 12 until node 16 reports via communication means 106 that the overstock merchandise has been received. In this embodiment, IMS 100 has notified node 12 that node 16 is interested in the overstock for SKU 23456789. IMS 100 also notifies node 12 that node 16 has submitted payment for the overstock inventory by communicating to node 12 a payment notice 400. In a preferred embodiment, IMS 100 has also assured that the payment from node 16 clears (e.g., sufficient funds). Node 12 will then ship the overstock inventory 402 to node 16 using common shipping means. Once the overstock inventory is received by node 16, then node 16 will submit a shipment received report 404 to IMS 100, which in turn releases the funds to node 12. At node 12's option, the payment can be received by check or can remain with IMS 100 as a credit towards future purchases of overstock inventory from another node 101.

In a particularly preferred embodiment once a match is made by EPM 108 of IMS 100 and communicated to, and accepted by two nodes, e.g., node 12 and node 16, the nodes are put in direct contact through to complete the transaction through IMS 100. In one particularly preferred embodiment, the two nodes are put in email communication facilitated by IMS 100 and EPM 108 to complete the transaction. In an alternative particularly preferred embodiment, the two nodes are placed into a temporary private webpage by IMS 100 wherein the parties to the two nodes, e.g., node 12 and node 16 can complete their negotiations and finalize the transaction. In either instance, it is preferred that the identities of nodes 12 and 16 are withheld until payment is made. For example, once the buyer and seller node have agreed upon the price and shipment terms for the mis-stocked inventory, the seller node pays a commission to the manager of the IMS 100, typically through the use of a credit card or other payment means. Upon receipt of the payment, the IMS 100 releases the identifies of each node, so that the transaction can be finally completed and the inventory shipped to the buyer node.

Alternatively, in this embodiment wherein IMS 100 acts to hold payment to assure that each node is meeting its end of the transaction, IMS 100 may charge an additional fee to one or both of the nodes 12 and 16 to cover any credit card fee for the cost of the inventory. However, this alternative embodiment is optional.

At the end of the transaction, node 12 has fewer SKU 23456789 shoes which were not selling in node 12's specific demographic market and has cash available with which to order merchandise with a higher likelihood of selling. Node 16 has more of that product which does sell in node 16's market. Preferably, the IMS 100 manager has earned a fee for facilitating the transfer

Those ordinarily skilled in the art will immediately recognize the versatility of the current invention and will apply the invention inventory management system to a variety of different inventory items. The inventory items may vary from the shoes of the current example without departing form this disclosed invention. Similarly, the methods for practicing this invention and the means for accomplishing these method steps are versatile. Steps may present in different order, or may be omitted. Additional steps may be added to the method steps presented. These variations are well within the spirit of the current invention.

I claim:

1. An in silico enabled inventory management system, the system comprising:
(a) at least two nodes;
(b) a communication means; and
(e) an exchange processing means,
wherein the nodes communicate an inventory data to the inventory management system, and the communicated inventory data is compared by the exchange processing means for compatibility and compatible matches are communicated back to the nodes.

2. The system of claim 1 wherein the at least two nodes are businesses dealing with inventory and having mis-stock of inventory.

3. The system of claim 2 wherein each of the at least two nodes comprises retailers, suppliers, manufacturers or distributors.

4. The system of claim 3 wherein each of the at least two nodes comprises retailers.

5. The system of claim 1 wherein the communication means is a means comprising a computer and monitor, a telephone, a facsimile machine and combinations thereof.

6. The system of claim 5 wherein the communication means is a computer and monitor linked to the internet.

7. The system of claim 5 wherein the communication means further comprises a data input means and a data receipt means.

8. The system of claim 7 wherein the data input means comprises a computer keyboard, a microphone or a scanner and the data receipt means comprises a computer monitor, a speaker or a printer.

9. The system of claim 5 wherein the communication means employed by one of the nodes of at least two nodes is a different communication means than is employed by another node of the at least two nodes.

10. The system of claim 1 wherein the at least two nodes communicate inventory data to the exchange processing means.

11. The system of claim 10 wherein the at least two nodes communicates a stock keeping unit as the inventory data to the exchange processing means.

12. The system of claim 1 wherein the exchange processing means comprises an inventory data storage function, an inventory data comparison function and a comparison communication function for receiving and comparing inventory data.

13. The system of claim 12 wherein the exchange processing means further comprises a complementary match ranking function for communicating the most relevant complementary match to at least one node of the at least two nodes.

14. The system of claim 12 wherein the exchange processing means further comprises a transaction management function for orchestrating payment and inventory shipping by and between nodes determined to have complementary matching inventory.

15. The system of claim 1 wherein the identity of the nodes of the at least two nodes is withheld.

16. The system of claim 1 wherein the nodes of the at least two nodes are authorized to deal with the inventory.

17. A method for managing inventory using the system of claim 1.

18. An in silico implemented method of managing inventory comprising the steps of:
(a) having at least two nodes;
(b) communicating mis-stocked inventory data to an inventory management system;
(c) comparing inventory data communicated by the at least two nodes using the inventory management system;
(d) communicating complimentarily matched inventory data to the at least two nodes by the inventory management system.

19. The inventory management method of claim 18 further comprising the step of:
(a) facilitating a transaction between the at least two nodes that have been determined to have complementarily matching mis-stocked inventory data using the inventory management system.

20. The inventory management method of claim 18 further comprising the step of:
(a) managing the nodes of at least two nodes using the inventory management system.

21. The inventory management method of claim 20 wherein the step of managing the nodes comprises maintaining the identity of the nodes in private.

22. The inventory management method of claim 20 wherein the step of managing the nodes comprises authenticating the node.

23. The inventory management method of claim 18 wherein the nodes of the at least two nodes are businesses dealing with inventory and having mis-stock of a particular inventory.

24. The inventory management method of claim 23 wherein the step of communicating mis-stocked inventory data between the at least two nodes and the inventory management system uses a communication means comprising a computer and monitor, a telephone, a facsimile and combinations thereof.

25. The inventory management method of claim 24 wherein the step of communicating uses a computer and monitor connected to the internet.

26. The inventory management method of claim 18 wherein the step of communicating mis-stocked inventory data to the inventory management system uses an industry-wide acceptable descriptors to identify the inventory.

27. The inventory management method of claim 26 wherein the step of communicating mis-stocked inventory data to the inventory management system uses a stock keeping unit to identify the inventory.

28. The inventory management method of claim 18 wherein the step of comparing inventory data further comprises a function for ranking complementarily matched inventory data.

29. The inventory management method of claim 18 wherein the step of communicating complimentary matched data between the inventory management system and the at least two nodes comprises a telephone, a computer and monitor, a facsimile and combinations thereof.

30. The inventory management method of claim 29 wherein the step of communicating uses a computer and monitor connected to the internet.

31. An internet based inventory management method comprising the steps of:
(a) having at least two retailers in the shoe retail business connected to an inventory management system;
(b) communicating mis-stock of shoe inventory to the inventory management system using a computer and monitor that accesses the inventory management system via the internet;
(c) comparing the communicated mis-stock of shoe inventory to determine complementarily matched mis-stock of shoe inventory; and
(d) communicating the complementarily matched mis-stock of shoe inventory to the corresponding retailers of the at least two retailers using the internet.
